(19) United States
(12) Patent Application Publication
(10) Pub. No.: US 2013/0187813 A1
(43) Pub. Date: Jul. 25, 2013

(54) METHOD FOR MANUFACTURING SENSING ELECTRICAL DEVICE AND SENSING ELECTRICAL DEVICE

(71) Applicant: TAIWAN GREEN POINT ENTERPRISES CO., LTD., Taichung (TW)

(72) Inventors: Sheng-Hung Yao, Taichung (TW); Cheng-Yen Wang, Taichung (TW); Hui-Mei Chang, Taichung (TW)

(73) Assignee: TAIWAN GREEN POINT ENTERPRISES CO., LTD., Taichung (TW)

(21) Appl. No.: 13/748,063

(22) Filed: Jan. 23, 2013

Related U.S. Application Data
(60) Provisional application No. 61/589,940, filed on Jan. 24, 2012.

(51) Int. Cl. H01Q 7/00; C23C 28/02

(52) U.S. Cl. CPC H01Q 7/00; C23C 28/02
USPC 343/700 MS; 427/97.3; 427/595; 205/126; 156/245

(57) ABSTRACT

A method for manufacturing a sensing electrical device includes the following steps; (a) forming a conductive trace on an insulating substrate; (b) placing the insulating substrate with the conductive trace in a mold cavity of a mold; (c) injecting an insulating material into the mold cavity to encapsulate the conductive trace to form an injection product; and (d) removing the injection product from the mold cavity.

### CROSS-REFERENCE TO RELATED APPLICATION

This application claims priority of U.S. Provisional Application No. 61/589,940, filed on Jan. 24, 2012.

### BACKGROUND OF THE INVENTION

1. Field of the Invention

This invention relates to an electrical device and a method for manufacturing the same, more particularly to a sensing electrical device and a method for manufacturing the same.

2. Description of the Related Art

In general, an antenna of a conventional mobile phone protrudes from a housing of the mobile phone in the form of an elongated rod, which makes the mobile phone bulky and complicated in appearance. Thus, in view of the trend toward requiring an electrical device to be light, thin, and small, an electrical device, more particularly a sensing electrical device, e.g., a mobile phone having an antenna or a touch sensor having a touch sensing circuit, is continuously developed to improve the configuration and size of the sensing electrical device.

The conventional sensing electrical device is typically designed to receive a printed circuit board having a conductive circuit (for example, an antenna metal plate of a mobile phone) in a housing thereof such that its appearance may be made simpler, and the outline of the same may be made smoother. In addition, the overall volume of the sensing electrical device may be effectively reduced.

Referring to FIG. 1, a conventional method for manufacturing the aforesaid electrical device involves press forming two plastic plates 11 and locking, latching, attaching, or laminating a printed circuit board 12 between the plastic plates 11.

Taiwanese Utility Model No. M323120 discloses an antenna metal plate sample for a mobile phone that is produced by preparing a thin template that is easy to cut and that is slightly larger than an antenna metal plate of a mobile phone, followed by cutting the thin template according to the size and shape of the antenna metal plate of the mobile phone.

In the aforesaid prior art, the printed circuit board 12 or the antenna metal plate and a housing (e.g., two plastic plates 11) are manufactured individually and then are bonded together, and thus the manufacturing process of the electrical device is somewhat complicated. Moreover, during assembly, the antenna metal plate or the printed circuit board 12 may not be precisely disposed in the housing, and a gap might be undesirably formed. The gap would cause the antenna metal plate or the printed circuit board 12 to be in contact with the ambient air, thereby resulting in possible short circuit or damage to the antenna metal plate or the printed circuit board 12 due to moisture in the air.

### SUMMARY OF THE INVENTION

Therefore, an object of the present invention is to provide a sensing electrical device and a method for manufacturing the same that can overcome the aforesaid drawbacks associated with the prior art.

According to one aspect of this invention, a method for manufacturing a sensing electrical device comprises the following steps:

(a) forming a conductive trace on an insulating substrate;

(b) placing the insulating substrate with the conductive trace in a mold cavity of a mold;

(c) injecting an insulating material into the mold cavity to encapsulate the conductive trace to form an injection product; and

(d) removing the injection product from the mold cavity.

According to another aspect of this invention, a sensing electrical device is manufactured by the aforesaid method of this invention.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic sectional view illustrating the process for manufacturing a conventional electrical device;

FIG. 2 is a flow chart illustrating the first preferred embodiment of a method for manufacturing a sensing electrical device according to the present invention;

FIG. 3 illustrates a step of forming a conductive trace on an insulating substrate of the first preferred embodiment;

FIG. 4 is a schematic sectional view illustrating a step of injecting an insulating material into a mold cavity to encapsulate the insulating substrate and the conductive trace of the first preferred embodiment;

FIG. 5 is a schematic sectional view showing the electrical device formed by the first preferred embodiment;

FIG. 5 illustrates a step of forming a conductive trace on an insulating substrate in the second preferred embodiment;

FIG. 7 illustrates a step of forming a conductive trace on an insulating substrate in the third preferred embodiment;

FIG. 8 illustrates a step of forming a conductive trace on an insulating substrate in the fourth preferred embodiment; and

FIG. 9 illustrates a step of forming a conductive trace on an insulating substrate in the fifth preferred embodiment.

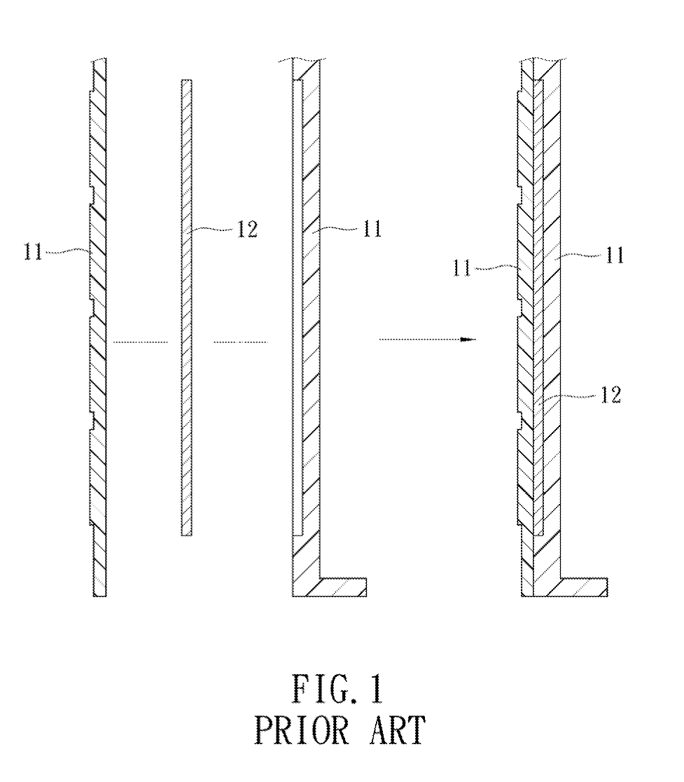

### DETAILED DESCRIPTION OF THE PREFERRED EMBODIMENTS

Before the present invention is described in greater detail, it should be noted that like components are assigned the same reference numerals throughout the following disclosure.

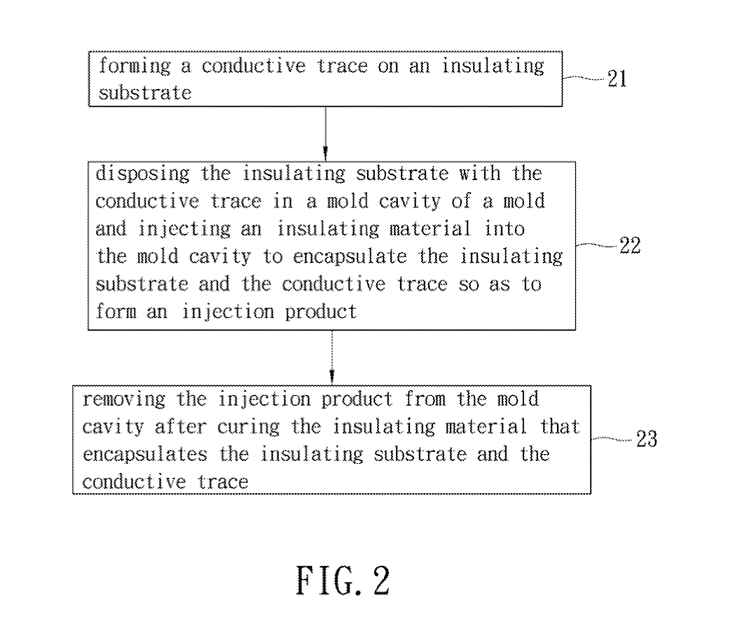

Referring to FIG. 2, the first preferred embodiment of a method for manufacturing a sensing electrical device according to the present invention comprises a step 21, a step 22 and a step 23.

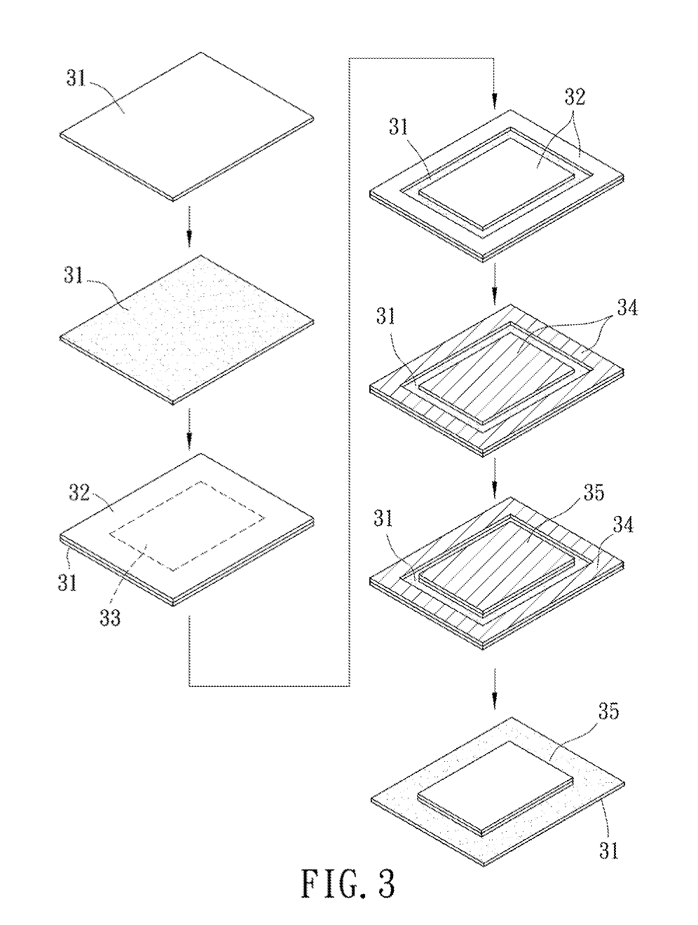

Referring to FIGS. 2 and 3, step 21 involves forming a conductive trace 35 on a trace forming region of an insulating substrate 31. In this embodiment, the insulating substrate 31 includes, but is not limited to, a polycarbonate film. The insulating substrate 31 is first subjected to laser ablation to form a roughened surface, i.e., the dotted surface shown, in FIG. 3, and is defined to have a trace forming region on which the conductive trace 35 is to be formed.

Then, the roughened insulating substrate 31 is immersed in an active metal containing solution, which is, in this embodiment, a palladium chloride solution, so that an active layer 32 composed of palladium chloride is formed on the entire roughened surface of the insulating substrate 31.

Next, the active layer 32 that surrounds the trace forming region is removed by laser ablation until the insulating substrate 31 is exposed so as to divide the active layer 32 into a plating region 33 corresponding in position to the trace forming region, and a non-plating region that is separated from the plating region 33 by the exposed insulating substrate 31. After the laser treatment, a periphery of the plating region 33 of the active layer 32 would have laser markings.

Next, the insulating substrate 31 with the active layer 32 is immersed in a chemical plating solution to convert the active layer 32 into a first metal layer 34 by chemical plating using redox principle. In this preferred embodiment, the insulating substrate 31 is immersed in a chemical plating solution containing nickel ions at a temperature ranging from 40° C. to 65° C. for 1 to 5 minutes to convert the active layer 32 in the plating region 33 and the non-plating region into the first metal layer 34.

It is noted that the chemical plating solution containing copper may be used instead of the chemical plating solution containing nickel. When the chemical plating solution containing copper is used as the chemical plating solution, the chemical plating is also conducted at a temperature ranging from 40° C. to 65° C. for 1 to 5 minutes.

Next, the insulating substrate 31 that is formed with the first metal layer 34 is immersed in a plating solution, and the first metal layer 34 in the plating region 33 is connected to an electrode (not shown) that serves as a plating electrode, followed by electroplating the first-metal layer 34 in the plating region 33 so as to form a second metal layer on the first metal layer 34, thereby forming a conductive trace 35 composed of the first metal layer 34 and the second metal layer on the trace forming region of the insulating substrate 31. The material for the first metal layer 34 is different from that of the second metal layer. Since the first metal layer 34 in the non-plating region is electrically separated from that in the plating region 33, and since the plating electrode is not disposed on the non-plating region, the second metal layer will not be formed in the non-plating region. Therefore, the conductive trace 35 and the first metal layer 34 formed in the non-plating region can be distinguished from each other.

When the first metal layer 34 formed by chemical plating is made of nickel, a copper layer may be formed as the second metal layer by electroplating at 20° C. to 45° C. for 2 to 50 minutes. When the first metal layer is made of copper, a nickel layer may be formed as the second metal layer by electroplating at 40° C. to 60° C. for 2 to 50 minutes.

Next, the first metal layer 34 in the non-plating region is removed using a stripper so as to leave the conductive trace 35 on the trace forming region of the insulating substrate 31. The stripper is selected so that only the first metal layer 34 formed in the non-plating region is removed. For example, when the first metal layer 34 formed by chemical plating is made of nickel, and the second metal layer formed by electroplating is made of copper, the stripper should be a nickel stripper. It should be noted that since the first metal layer 34 of the conductive trace 35 on the trace forming region of the insulating substrate 31 is covered by the second metal layer, the stripper for removing the first metal layer 34 has minimal influence on the first metal layer 34 of the conductive trace 35.

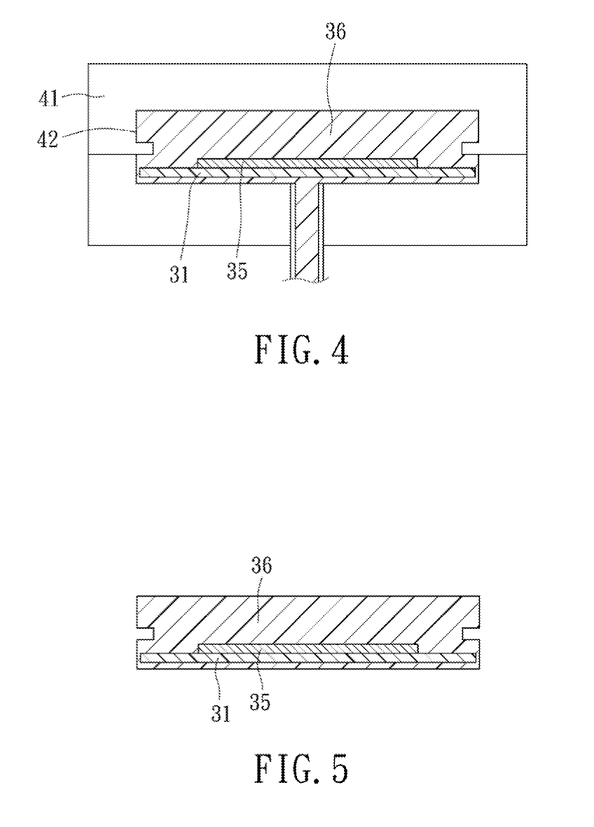

Referring to FIGS. 2 and 4, in step 22, the insulating substrate 31 with the conductive trace 35 is disposed in a mold cavity 42 of a mold 41. An insulating material 36 is injected into the mold cavity 42 to encapsulate the insulating substrate 31 and the conductive trace 35 so as to form an injection product. The insulating material 36 is a molten plastic material, for example, polyacetylene (PA) or polycarbonate (PC).

Preferably, to completely isolate the conductive trace 35 from the external environment, injection of the insulating material 36 into the mold cavity 42 of the mold 41 is continuously conducted until the insulating material 36 completely encapsulates the insulating substrate 31. However, it should be noted that, the insulating substrate 31 may not be encapsulated by the insulating material 36 as long as the conductive trace 35 is enclosed.

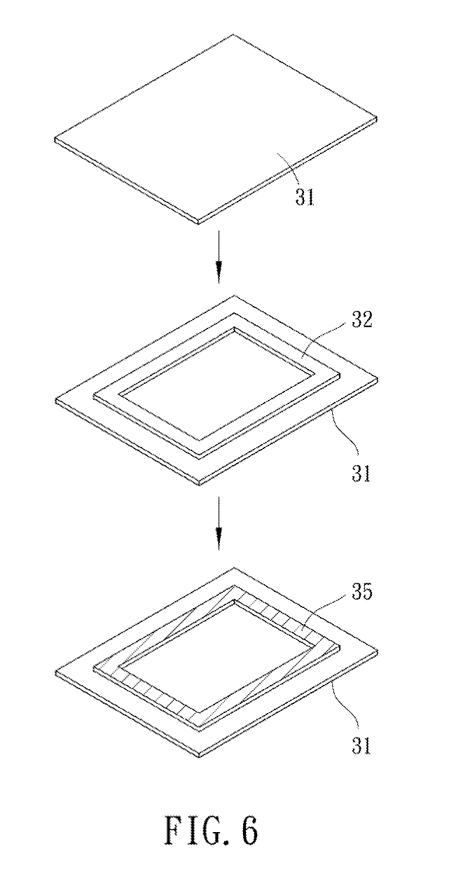

Referring to FIGS. 2 and 5, in step 23, the injection product is removed from the mold cavity 42 after curing the insulating material 36 that encapsulates the insulating substrate 31 and the conductive trace 35, followed by trimming flash formed on the injection product so as to obtain a sensing electrical device (see FIG. 5).

The sensing electrical device of this invention may be applied in a mobile phone or a touchpad.

In the case that the sensing electrical device is applied in a mobile phone, the conductive trace 35 is used as a concealed antenna that is formed without increasing the volume of the mobile phone. An electrical signal may be received and transmitted through the antenna in the mobile phone by virtue of wireless transmission (for example, bluetooth transmission or infrared transmission). In the case that the sensing electrical device is applied in a touchpad, the insulating material 36 on the conductive trace 35 is adjusted to have a smaller thickness and the touchpad is pressed to produce a piezoelectric effect, thereby generating an electrical signal.

Since the conductive trace 35 is encapsulated in the insulating material 36 so as to prevent adverse affect attributed to the external environment (for example, moisture), the reliability and the service life of the sensing electrical device can be effectively increased.

In the method of the present invention, the insulating substrate 31 with the conductive trace 35 is placed in the mold cavity 42, followed by injecting the insulating material 36 into the mold cavity 42 to encapsulate the insulating substrate 31 and the conductive trace 35. In this way, the drawback of complicated process, i.e., separately producing and assembling the housing and the conductive trace associated with the prior art can be eliminated. In addition, the volume of the sensing electrical device may be further reduced. Also, since the conductive trace 35 and the insulating substrate 31 are encapsulated in the insulating material 36, the conductive trace 35 can be protected from being damaged due to the moisture in the air, thereby dramatically increasing the reliability and the service life of the sensing electrical device.

Furthermore, since, in step 21, the second metal layer is formed to cover the first metal layer 34 and the materials for the first metal layer 34 and the second metal layer are designed to be different, the conductive trace 35 and the first metal layer 34 in the non-plating region can be distinguished from each other. Therefore, the first metal layer 34 in the non-plating region can be removed directly using a stripper.

Referring to FIGS. 2 and 6, the second preferred embodiment of a method for manufacturing a sensing electrical device according to the present invention is similar to that of the first preferred embodiment except for step 21, i.e., the step of forming the conductive trace 35 on the insulating substrate 31.

In the second preferred embodiment, step 21 is conducted by forming an active layer 32 on the trace forming region of the insulating substrate 31 where the conductive trace 35 is to be formed. Specifically, palladium chloride is printed directly on the trace forming region of the insulating substrate 31 using a jet-printing process to form the active layer 32. The printing principle of the jet-printing process is similar to that of a printer. In addition to the jet-printing process, a digital-printing process may be used to form the active layer 32 on the trace forming region of the insulating substrate 31. In this case, the active layer 32 can be formed in an automatic control manner without using a mask to define the trace forming region of the insulating substrate 31.

Next, the insulating substrate 31 with the active layer 32 is immersed in a chemical plating solution to convert the active layer 32 into the first metal layer 34. Since the active layer 32 is formed only on the trace forming region of the insulating substrate 31, a stripper for removing a metal layer outside the trace forming region is not required in this embodiment. Thus, an electroplating procedure can be omitted and the first metal layer 34 formed by chemical plating can be directly used as the conductive trace 35.

Preferably, the conductive trace 35 is made from copper, nickel, or the combination thereof.

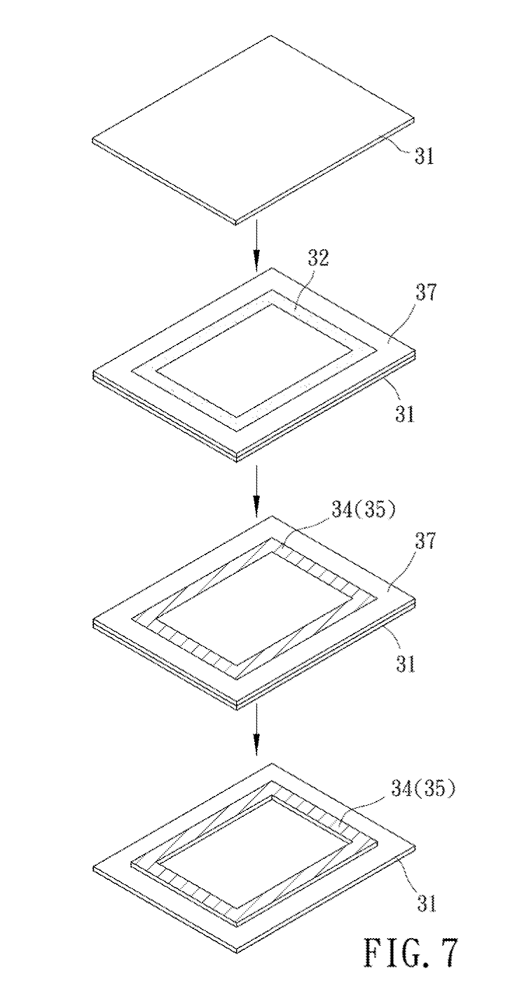

Referring to FIGS. 2 and 7, the third preferred embodiment of a method for manufacturing a sensing electrical device according to the present invention is similar to that of the second preferred embodiment except that the active layer 32 in step 21 is formed in a different manner.

In this embodiment, step 21 is conducted by forming a catalytic layer 3 on an entire surface of the insulating substrate 31 followed by defining the position of the trace forming region of the insulating substrate 31. The trace forming region may be defined using a mask such that the catalytic layer 37 outside the trace forming region is masked and the catalytic layer 37 on the trace forming region is exposed from the mask.

Next, the catalytic layer 37 on the trace forming region, i.e., exposed from the mask, is activated to form the active layer 32. In this embodiment, the catalytic layer 37 is mainly comprised of tin-palladium colloids that have palladium metals wrapped in colloids. The activation process is required to unwrap the palladium metals from the colloids so as to activate the tin-palladium colloids, thereby forming the active layer 32.

In addition, in this embodiment, the catalytic layer 37 is activated by ultraviolet light with a wavelength ranging from 200 nm to 400 nm. It is noted that activation of the catalytic layer 37 is not limited to radiation using ultraviolet light, and may be performed by any other suitable means. For example, a single laser beam may be used to activate the catalytic layer 37.

Next, the insulating substrate 31 with the active layer 32 is immersed in a chemical plating solution to convert the active layer 32 into the first metal layer 34. Since the active layer 32 is converted into the first metal layer 34 by virtue of redox reaction, the chemical plating is merely performed on the active layer 32 rather than on the catalytic layer 37. Therefore, the first metal layer 34 formed by chemical plating is only formed on the trace forming region and can be directly used as the conductive trace 35.

The catalytic layer 37 that is not converted into the first metal layer 34 is removed after the conductive trace 35 is formed.

Preferably, the first metal layer 34 is made from copper, nickel, or the combination thereof. Finally, the sensing electrical device is obtained after step 22 and step 23 are performed.

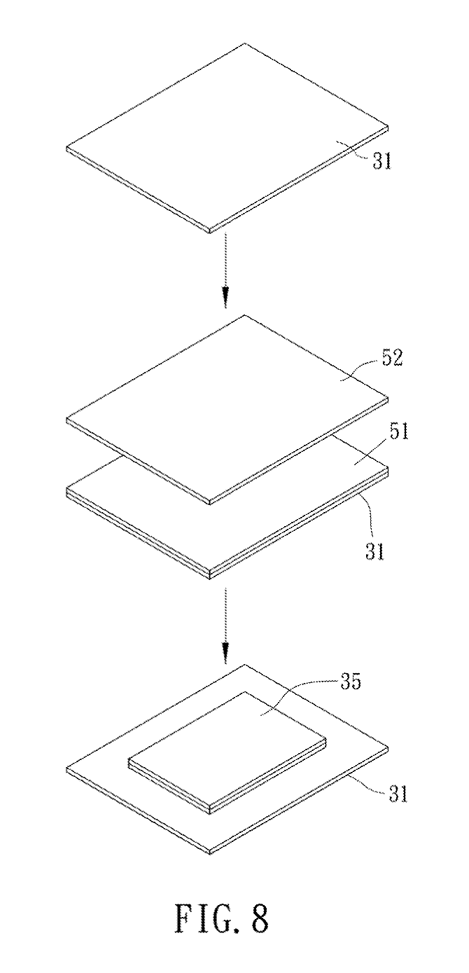

Referring to FIGS. 2 and 8, the fourth preferred embodiment of a method for manufacturing a sensing electrical device according to the present invention is similar to that of the first preferred embodiment except for step 21.

In this embodiment, step 21 is conducted by attaching a metal film 52 to an entire surface of the insulating substrate 31 using an adhesive 51.

Next, the metal film 52 is photolithographed to form the conductive trace 35 on the trace forming region of the insulating substrate 31. More specifically, the trace forming region where the conductive trace 35 is to be formed is masked by a photomask followed by removing the metal film 52 outside the trace forming region by an etching process so as to form the conductive trace 35 on the trace forming region of the insulating substrate 31. Finally, the sensing electrical device is obtained after step 22 and step 23 are preformed.

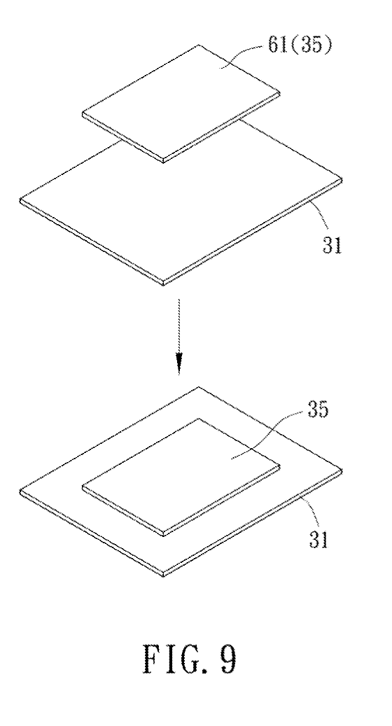

Referring to FIGS. 2 and 9, the fifth preferred embodiment of a method for manufacturing a sensing electrical device according to the present invention is similar to that of the first preferred embodiment except for step 21.

In this embodiment, step 21 is conducted by attaching a printed circuit board 61 as the conductive trace 35 onto the trace forming region of the insulating substrate 31. The printed circuit board 61 may be a single-layer or a multi-layer printed circuit board. In addition, the printed circuit board 61 may be a soft and flexible printed circuit board. Finally, the sensing electrical device is obtained after step 22 and step 23 are preformed.

In summary, in the method of the present invention, the insulating substrate 31 with the conductive trace 35 is placed in the mold cavity 42 of the mold 41, followed by injecting the insulating material 36 into the mold cavity 42 to encapsulate the insulating substrate 31 and the conductive trace 35. In this way, the manufacturing process of the sensing electrical device can be simplified and the volume of the resultant sensing electrical device can be reduced. In addition, the conductive trace 35 may be applied as a concealed antenna or a touch sensing circuit without resulting in a larger thickness of a housing of the sensing electrical device. Furthermore, the conductive trace 35 could be protected from contact with moisture in the air, thereby increasing the reliability and the service life of the sensing electrical device.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for manufacturing a sensing electrical device, comprising the following steps:
(a) forming a conductive trace on an insulating substrate;
(b) placing the insulating substrate with the conductive trace in a mold cavity of a mold;
(c) injecting an insulating material into the mold cavity to encapsulate the conductive trace to form an injection product; and
(d) removing the injection product from the mold cavity.

2. The method for manufacturing the sensing electrical device as claimed in claim 1, wherein step (d) is conducted after the insulating material is cured.

3. The method for manufacturing the sensing electrical device as claimed in claim 1, further comprising, after step (d), a step (e) of trimming flash formed on the injection product.

4. The method for manufacturing the sensing electrical device as claimed in claim 1, wherein step (a) is conducted by forming an active layer on a trace forming region of the insulating substrate where the conductive trace is to be formed and chemical plating the active layer to convert the active layer into the conductive trace.

5. The method for manufacturing the sensing electrical device as claimed in claim 4, wherein, in step (a), the active layer is composed of palladium chloride, and the conductive trace is made from copper, nickel, or the combination thereof.

6. The method for manufacturing the sensing electrical device as claimed in claim 4, wherein, in step (a), the active layer is formed by forming a catalytic layer on an entire surface of the insulating substrate followed by activating the catalytic layer on the trace forming region.

7. The method for manufacturing the sensing electrical device as claimed in claim 6, wherein the catalytic layer is activated by ultraviolet light.

8. The method for manufacturing the sensing electrical device as claimed in claim 1, wherein step (a) is conducted by forming an active layer on an entire surface of the insulating substrate, removing a part of the active layer until the insulating substrate is exposed so as to divide the active layer into a plating region and a non-plating region, converting the active layer into a metal layer by chemical plating, and electroplating the metal layer in the plating region to form the conductive trace.

9. The method for manufacturing the sensing electrical device as claimed in claim 8, wherein in step (a), removing the part of the active layer is conducted by laser.

10. The method for manufacturing the sensing electrical device as claimed in claim 8, wherein step (a) further includes, after electroplating, removing the metal layer in the non-plating region using a stripper.

11. The method for manufacturing the sensing electrical device as claimed in claim 1, wherein step (a) is conducted by forming a metal layer on an entire surface of the insulating substrate and photolithographing the metal layer so as to form the conductive trace on the insulating substrate.

12. The method for manufacturing the sensing electrical device as claimed in claim 1, wherein step (a) is conducted by attaching a printed circuit board having the conductive trace onto the insulating substrate.

13. A sensing electrical device manufactured by the method as claimed in claim 1.
